(19) United States
(12) Patent Application Publication
(10) Pub. No.: US 2015/0170604 A1
(43) Pub. Date: Jun. 18, 2015

(54) INTERIOR LIGHTING METHOD AND ORGANIC ELECTROLUMINESCENT ELEMENT PANEL

(71) Applicant: Konica Minolta, Inc., Chiyoda-ku, Tokyo (JP)

(72) Inventors: Masaru Iwagaki, Hachioji-shi (JP); Kozue Yogata, Shinjuku-ku (JP); Tomonari Asai, Hachioji-shi (JP); Satoshi Tomono, Yokohama-shi (JP); Kousuke Yoshii, Suginami-ku (JP)

(21) Appl. No.: 14/405,616

(22) PCT Filed: May 20, 2013
(86) PCT No.: PCT/JP2013/063897

§ 371 Date: Dec. 4, 2014

(30) Foreign Application Priority Data
Jun. 7, 2012 (JP) 2012-129450

(51) Int. Cl. G09G 5/02

(52) U.S. Cl. CPC G09G 5/02

(57) ABSTRACT

The problem addressed by the present invention is providing an interior lighting method, which resolves the sense of confinement and sense of oppression in the passenger compartment of a moving body for travelers and achieves a comfortable moving space for travelers, and an organic electroluminescent element panel used in the same. This passenger compartment lighting method is a passenger compartment lighting method by a lighting device provided on a window panel part inside the passenger compartment of the moving body for travelers and is characterized by simulating image information for outside of a window of the moving body for travelers and by making the lighting device emit light on the basis of that image information.

### TECHNICAL FIELD

The present invention relates to a passenger cabin lighting method by lighting equipment installed in a passenger cabin of a vehicle and an organic electroluminescent element panel used for the method. In particular, the present invention relates to a passenger cabin lighting method that uses lighting equipment including an organic electroluminescent element panel as a lighting member disposed on a window panel in a passenger cabin of an aircraft so as to eliminate a sense of confinement in the passenger cabin, and the organic electroluminescent element panel used for the method.

### BACKGROUND ART

When a passenger travels by a vehicle, he/she normally has to stay in a small mobile space for a long time, which makes him/her feel considerably cramped. In particular, if the vehicle is an aircraft, the windows are so small due to structural reasons that it evokes a significant sense of confinement. Furthermore, a long flight constrains him/her to keep a certain posture in a limited space for a long time, which builds up significant stress, too. Higher classes such as first class offer seats with a comfortable space that are arranged at suitable intervals so as to improve comfort to some extent. However, in terms of evoking a significant sense of confinement, they offer the same environment as the passenger cabin of economy class.

In recent years, there have been proposals for reducing such sense of confinement in a vehicle so as to improve comfort. For example, Airbus S.A.S. published a “conceptual cabin” on Jun. 14, 2011, which illustrated an imaginary passenger cabin in 2050s based on a concept of enjoying a flight 10000 m high in the air while watching a night sky panorama through a transparent airframe. In the proposed design, the whole passenger cabin is made of a transparent material instead of conventional small windows while the airframe structure is reinforced by reference to an avian skeleton structure, so that passengers can enjoy a panoramic view. Such configuration surely gives a sense of openness and eliminates a sense of confinement. However, the overall application of a transparent material increases the amount of structural material in order to maintain the strength of an airframe, which results in an increase in weight of the airframe. Furthermore, since passengers watch the view through the skeleton airframe during a flight over 10000 m in the air, some passengers who are scared of heights feel fear rather than a sense of openness.

In “Aircraft Interiors EXPO 2012” held in Hamburg, Germany on Mar. 27-29, 2012, BDLI (German Aerospace Industry) exhibited in its booth a method of installing a multifunctional display on an inner side wall of an airplane and displaying an actual outside image on the whole area of the display.

However, this method of installing a multifunctional display causes an increase of the total weight of an aircraft due to the considerable weight of the display itself. This has a significant influence on stable flight and causes an increase in fuel consumption and the like, which is environmentally unfavorable. Further, it is necessary to take a measure against negative influences such as the above-described passenger's fear caused by direct provision of the outside image.

Patent Document 1 discloses a method of lighting a passenger cabin by disposing an organic electroluminescent lighting panel on a ceiling of an aircraft passenger cabin in a direction parallel to the axis of the airframe. The method described in Patent Document 1 is to install an organic electroluminescent panel, which has light weight and low power consumption and is safe for a passenger cabin (low pyrophoric property and the like), as lighting equipment in replace of conventional passenger cabin lights such as fluorescent and LED lights, so as to secure high safety required for aircrafts and to reduce the weight and power consumption of aircrafts. However, the method described in Patent Document 1 only relates to a lighting member alternative to conventional lighting members, and does not eliminating a sense of confinement in a small passenger cabin, which, in turn, is an object of the present invention.

### PRIOR ART DOCUMENT

### Patent Document

Patent Document 1: JP2011-140264A

### SUMMARY OF INVENTION

### Problem to be Solved by the Invention

The present invention was made in consideration of the above-described problems, and an object thereof is to provide an interior lighting method that eliminates a sense of confinement and oppression in a passenger cabin of a vehicle so as to offer a comfortable passenger mobile space, and an organic electroluminescent element panel used for the method.

### Means for Solving the Problem

The present inventors conducted a diligent study for solving the above-described problems, and eventually found that it is possible to eliminate a sense of confinement and oppression in a small passenger cabin space to offer a comfortable and open passenger cabin space by providing lighting equipment on a window panel in a passenger cabin of a vehicle, simulating (un-imaging) image information on a scene outside a window of the travelling vehicle or the like, and allowing the lighting equipment installed on the window panel to emit light in a predetermined condition to light the passenger cabin, so as to obtain an illumination that resembles the scene outside the window, i.e. an illumination of an simulated image.

That is, the above-described object of the present invention is achieved by the following means.

1. A passenger cabin lighting method by lighting equipment that is provided on a window panel in a passenger cabin of a vehicle, comprising: simulating image information on an outside of a window of the vehicle; and allowing the lighting equipment to emit light based on the image information.

2. The passenger cabin lighting method according to claim 1, wherein the vehicle is an aircraft.

3. The passenger cabin lighting method according to claim 1 or 2, wherein the image information on the outside of the window is acquired by a sensor unit or a camera unit that is installed in the vehicle, and the acquired image information is simulated by an image processing unit, and wherein the lighting equipment disposed on the window panel emits light based on hue, brightness and saturation of the simulated image information.

4. The passenger cabin lighting method according to claim 1 or 2, wherein the image information on the outside of the window is analyzed based on positional information of the vehicle, time information and weather information, and is simulated based on the analyzed image information by an image processing unit, and wherein the lighting equipment disposed on the window panel emits light based on hue, brightness and saturation of the simulated image information.

5. The passenger cabin lighting method according to any one of claims 1 to 4, wherein the lighting equipment provided on the window panel comprises a plurality of lighting member that are arranged in separate blocks, and wherein the plurality of lighting members are organic electroluminescent element panels.

6. The passenger cabin lighting method according to any one of claims 1 to 5, wherein the step of simulating the image information on the outside of the window of the vehicle comprises the following sub-steps 1) to 3):

1) acquiring the image information on the outside of the vehicle by a sensor unit or a camera unit;

2) dividing the acquired image information; and

3) determining representative colors of respective divided image parts.

7. The passenger cabin lighting method according to claim 5 or 6, wherein the organic electroluminescent element panels have a light transmittance T of 65% or more at a wavelength of 550 nm in a non-light emitting state.

8. The passenger cabin light emitting method according to any one of claims 5 to 7, wherein the organic electroluminescent element panels are controllable in luminescent color.

9. An organic electroluminescent element panel used in the passenger cabin lighting method according to any one of claims 1 to 8.

### Effects of Invention

With the above-described means of the present invention, it is possible to provide an interior lighting method that can eliminate a sense of confinement and oppression in a passenger cabin of a vehicle so as to offer a comfortable passenger mobile space, and to provide an organic electroluminescent element panel used for the method.

The reasons the above-described problems can be solved by the configuration defined in the present invention are presumed as follows.

Most components of a passenger cabin of a vehicle, particularly an aircraft, are made of non-transparent light materials such as duralumin in order to ensure strength, and the only means for watching a scene outside the airframe is very small windows having a minimal area.

Staying in such a closed space for a long time is a factor causing a sense of confinement and oppression, and the resulting increasing stress. To cope with the problem, for example, there has been an attempt to eliminate a sense of confinement by mounting an image display panel on a window panel and displaying outside information on the image display panel as an actual image. However, since an outside image is displayed directly without any change, it gives a realistic fear of flying high in the air to passengers.

In the present invention, as a result of a diligent study for solving the above-described problem to eliminate a sense of confinement in a small passenger cabin, it became possible to eliminate a sense of confinement in a closed space and to offer a bright and open passenger cabin environment by disposing, to be specific, a plurality blocks of lighting members, preferably organic electroluminescent element panels (hereinafter referred to as organic EL element panels) on a window panel of a vehicle, simulating a light emitting condition based on image information acquired by a sensor unit or a camera unit installed in the vehicle or based on image information that is analyzed based on positional information of the vehicle, time information and weather information, and lighting the passenger cabin by allowing the lighting members to emit light in the particular lighting condition to display not an actual image but an simulated image that resembles the outside scene of the flying vehicle.

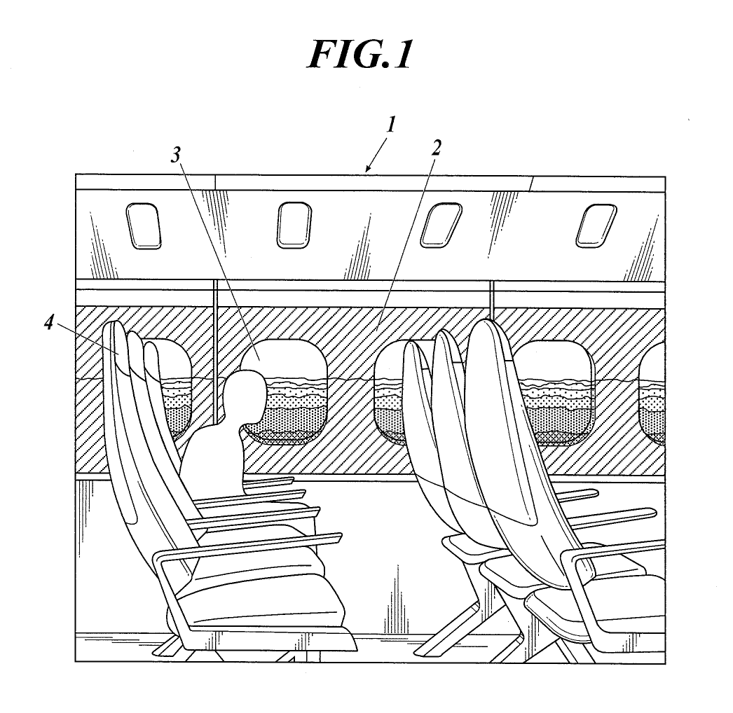

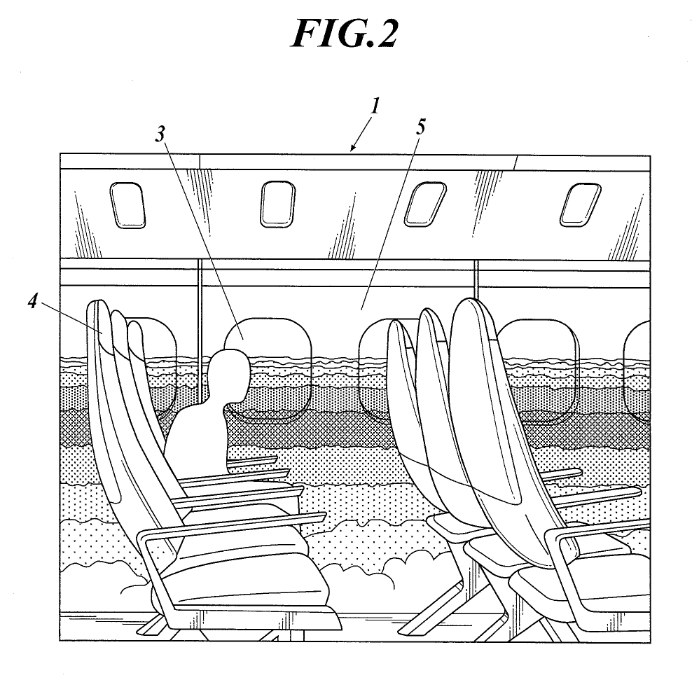

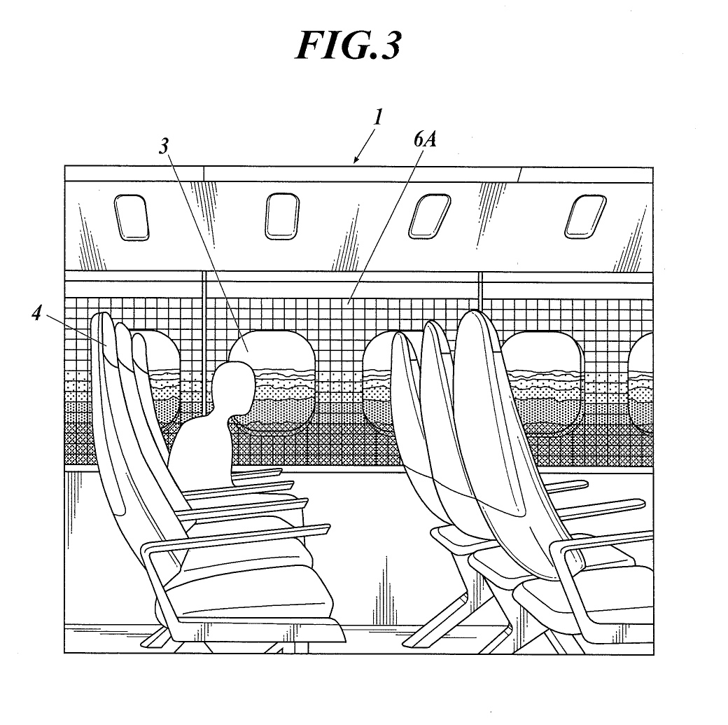

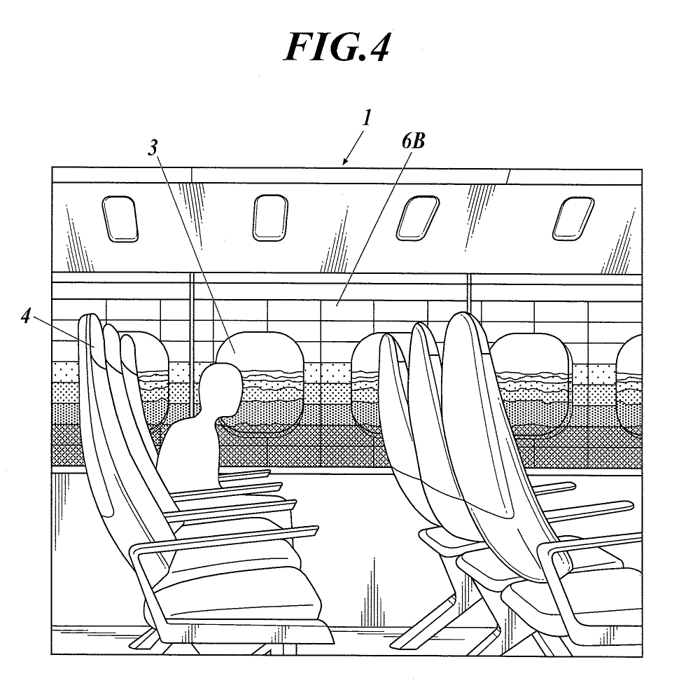

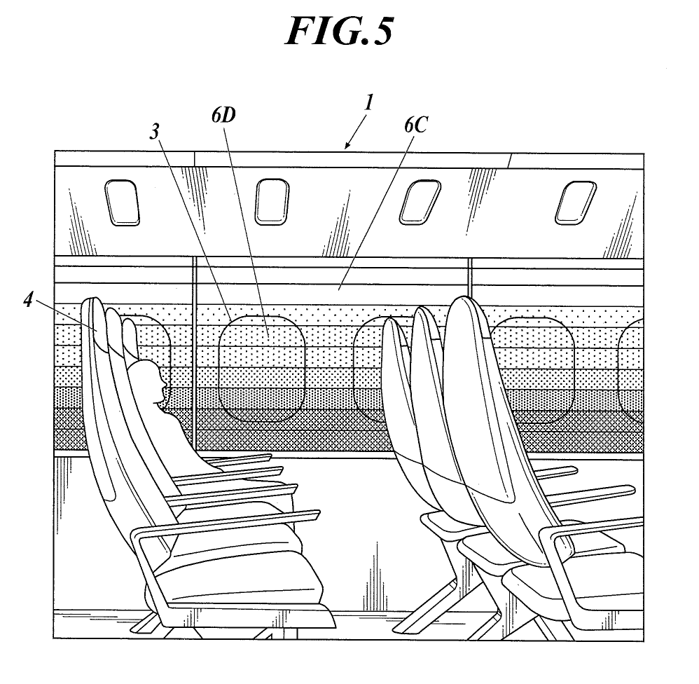

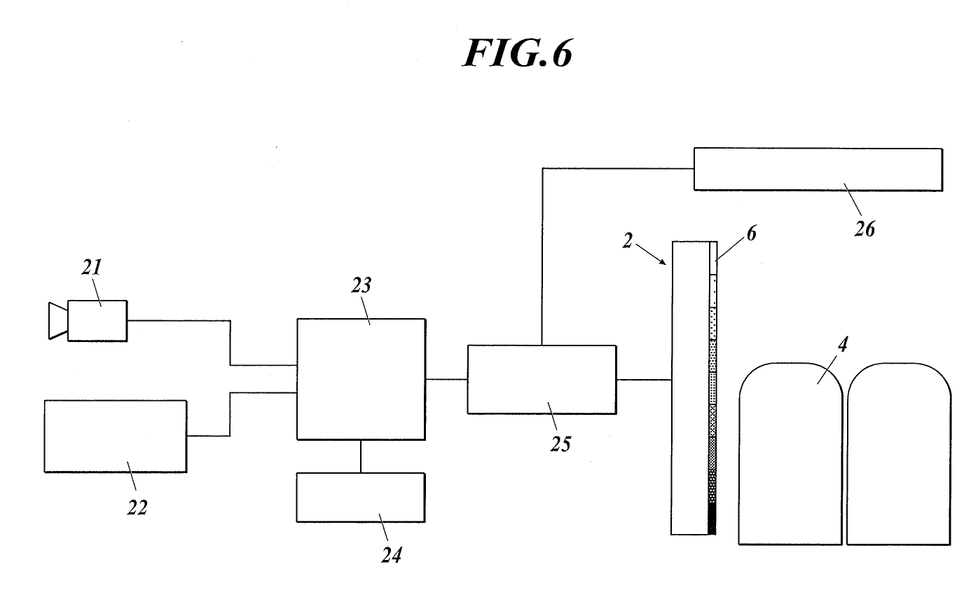

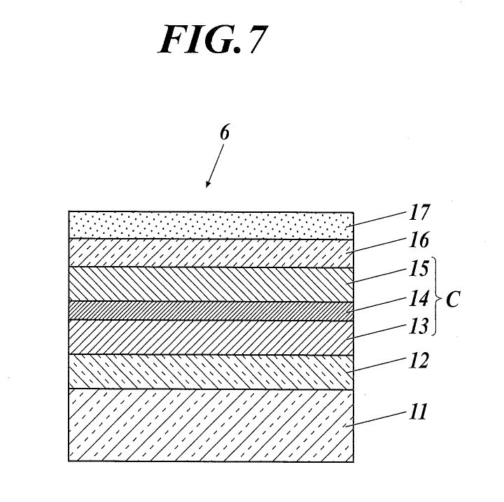

### BRIEF DESCRIPTION OF DRAWINGS

[FIG. 1] This is a schematic view illustrating an example of the configuration of a conventional passenger cabin of an aircraft as a vehicle.

[FIG. 2] This is a schematic view illustrating an example of a lighting method for comparison, in which an image display apparatus provided on a window panel of an aircraft passenger cabin displays an actual image.

[FIG. 3] This is a schematic view illustrating an example of a passenger cabin lighting method of the present invention, in which separate lighting members provided on a window panel emit light based on simulated information.

[FIG. 4] This is a schematic view illustrating another example of a passenger cabin lighting method of the present invention, in which separate lighting members provided on a window panel emit light based on simulated information.

[FIG. 5] This is a schematic view illustrating an example of a passenger cabin lighting method of the present invention, in which separate high-translucent lighting members provided on a window panel and windows emit light based on simulated information.

[FIG. 6] This is a flow diagram illustrating an example of image processing and simulation of outside information and a controlling method of a light emitting condition of lighting members.

[FIG. 7] This is a schematic cross sectional view illustrating an example of the configuration of an organic electroluminescent element panel according to the present invention.

### DESCRIPTION OF EMBODIMENTS

An interior lighting method of the present invention is a passenger cabin lighting method that uses lighting equipment installed on a window panel in a passenger cabin of a vehicle, and includes the steps of: simulating image information on an outside of a window of the vehicle; and allowing the lighting equipment to emit light based on the image information. This method can eliminate a sense of confinement and oppression in a passenger cabin of a vehicle so as to offer a comfortable passenger mobile space. This feature is a common technical feature of the invention recited throughout claims 1 to 9.

In an embodiment of the present invention, the vehicle is preferably an aircraft in terms of exerting the advantageous effects of the present invention.

In one of methods of determining a lighting condition in the passenger cabin, it is preferred that the image information on the outside of the window is acquired by a sensor unit or a camera unit installed in the vehicle, the acquired image information is simulated by an image processing unit, and the lighting equipment disposed on the window panel emits light based on hue, brightness and saturation of the simulated image information. In another method, it is preferred that the image information on the outside of the window is analyzed based on positional information of the vehicle, time information and weather information, and is simulated based on the analyzed image information by an image processing unit, and the lighting equipment disposed on the window panel emits light based on hue, brightness and saturation of the simulated image information.

Further, in a preferred embodiment, the lighting equipment provided on the window panel includes a plurality of lighting members that are segmented into blocks, and the plurality of lighting members are organic electroluminescent element panels.

Further, it is preferred that the step of simulating the image information on the outside of the window of the vehicle is composed of the sub-steps of 1) acquiring the image information on the outside of the vehicle by a sensor unit or a camera unit; 2) dividing the acquired image information; and 3) determining representative colors of respective divided image parts.

Further, it is preferred that the organic electroluminescent element panels have a light transmittance T of 65% or more at a wavelength of 550 nm in a non-light emitting state. It is preferred that the organic electroluminescent element panels have a controllable luminescent color.

Hereinafter, the present invention and the components thereof, and embodiments of the present invention will be described in detail with drawings. As used herein, the symbol “-” is intended to mean that the numbers before and after it are included as the lower limit and the upper limit of the range.

### Passenger Cabin Lighting Method

FIG. 1 is a schematic view illustrating an example of the configuration of a current passenger cabin of an aircraft as a vehicle.

As illustrated in FIG. 1, in the interior of a passenger cabin 1 of a conventional aircraft, a window panel 2 is disposed on the whole face of a wall located on one side of a seat 4. On parts of the wall, small windows 3 are provided.

The window panel illustrated in FIG. 1 is a wall structure that is made of an optically non-translucent material. It is obvious that outside information (e.g. scene) cannot be obtained through it, and the very small windows 3 are only means for getting information on the external environment. Passengers at the window side and passengers at the inner side have to stay in such a small closed area for a long time, and therefore feel a significant sense of confinement.

One of the methods known in the art for this problem is to provide an image display apparatus in a passenger cabin of an aircraft as illustrated in FIG. 2.

FIG. 2 is a schematic view illustrating an example of a lighting method for comparison, in which an image display apparatus is provided on a window panel in a passenger cabin of an aircraft for displaying an actual image.

In the method of FIG. 2, images are taken by an external camera unit that is disposed on the bottom of the airframe or at the tip of the tail of the aircraft as a vehicle, and the images are projected on an image display member 5, e.g. a monitor such as liquid crystal display device, disposed on the window panel of a passenger cabin 1, so that the same environment as the windows 3 is created on the whole wall, i.e. a pseudo-skeleton airframe structure is created. The sense of confinement in the passenger cabin can be thus eliminated. However, since an actual image is projected on the whole face of the window panel in this method, it evokes fear rather than a sense of openness when the aircraft flies at high altitude. Furthermore, since the image display member 5 is disposed on the whole face of the window panel, its weight has an influence on the mass of the whole aircraft, which results in a degradation in economic efficiency of the cruise.

Regarding this problem, the passenger cabin lighting method of the present invention, which uses the lighting equipment disposed on the window panel in the passenger cabin of the vehicle, is characterized in that the lighting equipment emits light based on image information on the outside of windows of an aircraft, and the image information is not an actual image but simulated information. As used herein, a vehicle is a means for carrying a number of passengers, specifically a transportation means having a closed space such as aircraft, passenger train, large-size bus, ship and elevator. An aircraft is preferred. Hereinafter, the passenger cabin lighting method of the present invention will be described with an aircraft as a representative example.

FIG. 3 is a schematic view illustrating an example of the passenger cabin lighting method of the present invention, in which separate lighting members are provided on a window panel to emit light based on simulated information. Further, FIG. 4 is a schematic view illustrating another example in which lighting members 6B with a larger size are disposed instead of the separate lighting members 6A of FIG. 3.

In FIG. 3 and FIG. 4, the lighting members 6A, e.g. organic EL element panels, are disposed on the window panel of the passenger cabin 1 in a plurality of separate blocks. The external environment of the airframe is analyzed based on information from a camera unit installed in the vehicle, information from a color and illumination sensor, information on recorded past flights, and information taken from different measuring devices installed in a cockpit such as positional information of the aircraft, time information and weather information. Thereafter, the external environment is simulated according to a certain condition, and the organic EL element panels 6A or 6B disposed on the window panel of the passenger cabin 1 then emit light based on the simulated information to light the passenger cabin. Each of the organic EL element panels 6A or 6B disposed on the window panel does not display an actual image as illustrated in FIG. 2, because each of the panels does not display an image but emits uniform single-color light. Therefore, a sense of confinement is eliminated without evoking unintended fear, and a comfortable space can thus be provided.

In the passenger cabin lighting method of the present invention, preferred lighting methods according to a simulated condition by using the organic EL element panels 6A or 6B disposed on the window panel includes: an interior lighting method, wherein the image information on the outside of the window is acquired by a sensor unit or a camera unit that is installed in the vehicle, and the acquired image information is simulated by an image processing unit, and wherein the lighting equipment disposed on the window panel emits light based on hue, brightness and saturation of the simulated image information, which is the invention recited in claim 3; or an interior lighting method, wherein the image information on the outside of the window is analyzed based on positional information of the vehicle, time information and weather information, and is simulated based on the analyzed image information by an image processing unit, and wherein the lighting equipment disposed on the window panel emits light based on hue, brightness and saturation of the simulated image information, which is the invention recited in claim 4.

In FIG. 6, an example of the image processing and simulation of the outside information and the method of controlling the light emitting condition of the lighting equipment based on the simulated information is described with the flow diagram.

The information analysis on hue, brightness and saturation is carried out based on the image information taken by a sensor unit or a camera unit 21 installed in the airframe of the vehicle, the positional information of the aircraft from different instruments installed in a cockpit 22, the time information and the weather information, or based on the past flight information stored in a recording unit 24. Based on the result of the analysis, the simulation processing is carried out in an image processing unit 23. Then, an image controlling unit 25 allows organic EL element panels 6, which are the plurality of light emitting members disposed on the window panel 2, to emit light in an optimal condition according to a light emitting condition (hue, brightness and saturation) that conforms to the image information on the outside of the aircraft. In this regard, the light emitting conditions of respective organic EL element panels 6 are each independently controlled. Specifically, the amount and hue of each light are controlled to respective optimal conditions according to the information on the outside of the aircraft. Further, it is preferred that an onboard lighting controlling section 26 controls main lighting equipment of the passenger cabin in conjunction with the light emitting members (organic EL element panels) 6, so as to suitably control the overall amount of light in the passenger cabin.

As used herein, the window panel 2 refers to a window panel unit that includes the windows 3 and the surrounding inner wall. The lighting equipment is provided on the surface of this window panel 2. Regarding the area of the lighting equipment on the window panel, it is preferred that the lighting equipment is disposed such that the lower end is located at the level of the feet or wrest of passengers and the upper end reaches the end of a hand baggage storage. A preferred area is such an area that would give a sense of openness if it were a window of the vehicle.

It is preferred that the window panel lighting member disposed on the surface of the window panel unit is composed of a single lighting unit per each window panel unit. However, it is more preferred that the lighting equipment is composed of a plurality of separate blocks that are driven independently from each other on the window panel unit as illustrated in FIG. 3 or FIG. 4.

It is preferred that the light emitting members, which are installed as the plurality of blocks on the window panel unit, are made of organic EL element panels, which are thin, light and flexible and produce less heat. Further, it is particularly preferred that the light emitting members are made of transparent organic EL element panels that have an optical transmittance T of 65% or more at a wavelength of 550 nm in a non-light emitting state (off state). With such transparent organic EL element panels, it becomes possible to show the color, pattern and texture of the inner wall material of the window panel unit in the aircraft when the window panel lighting unit is not in operation.

Further, if transparent organic EL element panels 6D are disposed also on the windows 3 as illustrated in FIG. 5, it is possible to enjoy the scene from the windows as usual when the lighting equipment disposed on the window panel is not in operation, because they have high transmittance.

In the passenger cabin lighting method of the present invention, the lighting members (organic EL element panels) mounted on the window panel emit light according to a lighting condition that is simulated based on the analyzed information. As used herein, “simulation” means image processing according to the following procedure.

1) The image information on the outside of the aircraft acquired by the sensor unit or camera unit 21 or the like is divided into a plurality of sections from a sky section to a ground section (or sea surface section)

2) Representative colors of respective divided information sections are determined.

3) The lighting members 6 disposed on the window panel emit light in the representative colors corresponding to respective information sections such that the light emitting conditions are uniform in the horizontal direction as illustrated in FIG. 3 to FIG. 5.

4) The color of the lighting members 6 of the window panel 2 are adjusted to change gradually from the sky section to the ground section (or sea surface section) so that the color changes continuously.

Based on the simulated image information, the lighting members disposed on the window panel emit light. The lighting members are disposed on the window panel in the form of a plurality of separate blocks. The area of each lighting member 6 is preferably within the range from 10 to 1000 cm², more preferably within the range from 100 to 400 cm².

Each lighting member 6 may have any shape, but preferably has a shape that can cover the window panel without gaps. More preferred shapes are polygonal shapes (e.g. triangular, rectangular, pentagonal and hexagonal shapes) and a combination of different polygonal shapes. In particular, a square shape, a rectangular shape, and the combination thereof are particularly preferred.

It is preferred that the light emission of the lighting members 6 forms a gradation on the window panel 2. For example, in a specific example in which image information on the daytime outside of the windows is simulated, the upper part of the window panel displays a blue sky, the blue color gradually pales toward the lower part, the middle part displays white color in the image of clouds, and the blue color of the sea becomes deeper toward the lower part.

In another specific example in which image information on the evening outside of the windows is simulated, the upper part of the window panel displays a blue sky, the blue color fades toward the lower part while a sunset orange color appears and becomes deeper, the clouds reflecting the sunset light are displayed in shining orange in the middle part, and the blue color of the sea becomes darker to black color of the night toward the lower part. Further, it is preferred that change of the light emission according to the flight time, such as from early morning to daytime or from daytime to evening, is performed continuously and gradually.

It is preferred that the light emission is controlled to be the same in the horizontal direction of the window panel so as to express expansiveness and grandeur in the horizontal direction.

The simulated image information on the outside of the window is reproduced as a light emission pattern of the lighting equipment provided on the window panel. In the passenger cabin lighting method of the present invention as illustrated in FIG. 3 and FIG. 4, a preferred method of lighting the organic EL element panels 6A or 6B disposed on the window panel according to the simulated condition is to simulate and display the image information on the outside scene from the passenger cabin through the windows on the basis of the eye level of a passenger sitting on a seat. That is, it is preferred that the light emission is performed such that the horizon or a cloud sea line displayed on the lighting members on the window panel is aligned with the horizon or a cloud sea line when they are viewed from the eye level of a passenger who watches the outside from the windows sitting on a seat.

In the present invention, the lighting members 6 of the window panel 2 may be disposed covering the windows (glasses) as illustrated in FIG. 5. In this case, it is preferred that the lighting members are made of high-transparent organic EL element panels as described above (the organic EL element will be described in detail below). That is, when the lighting equipment is off, it is possible to enjoy the scene outside the windows because the organic EL element panels themselves are transparent. When the lighting equipment including the part on the windows (glasses) emits light, the light emission of whole window panel can express the simulated image of the outside of the window on the whole window side of the passenger cabin. Therefore, it becomes possible to create an open and comfortable space.

In the interior lighting method of the present invention, it is preferred that the lighting members are off during taking off and landing of the aircraft for safety reasons.

### Organic Electroluminescent Element Panel

### Configuration of Organic Electroluminescent Element Panel

It is preferred that the organic EL element panel of the present invention has a light transmittance T_{c} of 65% or more at a wavelength of 550 nm in a non-light emitting state.

As used herein, light transmittance T_{c} refers to transmittance that is measured using light having a maximal wavelength at 550 nm. Light transmittance T_{c} can be readily measured by using an ordinary spectrophotometer (e.g. U-3300, Hitachi, Ltd.).

In the present invention, the light transmttance of the organic EL element panel in a non-light emitting state means the total light transmittance at a wavelength of 550 nm of the components of the organic EL element panel including a substrate, a pair of planar electrodes, an organic functional layer including an organic light emitting layer, and a sealing layer. To achieve the desired light transmittance, it is important that each of these components has high light transmittance. In particular, it is important that the planar electrodes, which generally have low light transmittance, are designed to have high light transmittance. That is, an important factor to achieve the value of the light transmittance T_{c} as defined in the present invention is that a positive electrode, a negative electrode, and if necessary, an intermediate electrode all have high light transmittance. In addition, it is also preferred to devise a technique of laminating the organic functional layer such as organic light emitting layer so as to increase the light transmittance.

For the substrate and the sealing layer of the organic EL element panel, it is preferred to use a material having high light transmittance such as glass, quartz and plastic film. Increasing the light transmittances of respective components of the organic EL element panel enables to increase the light transmittance T_{c} to 65% or more. It is preferred to design the panel to have a light transmittance T_{c} within the range from 70% to 90%.

Further, in a preferred embodiment, the organic EL element panels according to the present invention are controllable in luminescent color so that they can reproduce the color of the simulated scene outside the aircraft.

As used herein, “controllable in luminescent color” means that the organic EL element panel can emit light in any color including three primary colors and other various intermediate colors according to the simulated information that is simulated from the image information on the outside of the aircraft acquired by the sensor unit or camera unit 21. A preferred organic EL element panel with this property is a white light emitting organic EL element panel that includes light emitting layers containing a blue light emitting compound, a green light emitting compound and a red light emitting compound as light emitting compounds.

Specific techniques to impart the color-controllable property to the organic EL element panel are known in the art, any of which can be employed.

For example, such techniques include:

1) a method of changing the luminescent color of a panel by using an organic EL element panel that includes pixels with different luminescent colors two-dimensionally arranged in the plane direction, and controlling the light emitting conditions of these pixels;

2) a method of controlling the luminescent color by laminating two or more light emitting layers with different luminescent colors, and shifting a light emitting center by adjusting a driving current or voltage;

3) a method of controlling the luminescent color by laminating two or more light emitting layers with different luminescent colors, and providing an electrochromic element, a photochromic element and a thermochromic element between the light emitting layers to perform an adjustment;

4) a method of controlling the luminescent color by laminating a plurality of light emitting units, each unit including two or more light emitting layers with different colors, and providing an intermediate electrode between the light emitting units to drive each light emitting unit individually; and

5) a method of controlling the luminescent color by overlapping two or more organic electroluminescent element panels having high light transmittance, and adjusting a light emitting drive of each panel individually.

These methods may be used alone or in suitable combination.

Regarding the major configuration of the organic EL element panel, it includes the pair of planar electrodes (positive electrode and negative electrode) on the substrate, and the organic functional layer including the organic light emitting layer between the planar electrodes. The organic functional layer generally includes a hole injection layer, a hole transport layer, a light emitting layer, an electron transport layer, an electron injection layer and the like, which are arranged in this order from the positive electrode. Depending on the properties of the materials used, a complex layer may be employed to decrease the number of layers, or another functional layer may be further added. For the configuration of the organic EL element panel, reference can be made to “Organic EL handbook” (Tetsuo Tsutsui (editorial supervisor), Realize Science & Engineering) and the like.

FIG. 7 is a schematic cross sectional view illustrating an example of the configuration of an organic EL element panel according to the present invention.

In FIG. 7, the organic EL element panel 6 is configured, for example, such that a transparent electrode 12 as the positive electrode is provided on a support substrate 11 made of a light permeable plastic film or glass, and an organic functional layer unit C is formed thereon. In addition to an organic light emitting layer 14, the organic functional layer unit C includes organic functional layers 13 and 15 such as a hole transport layer, a hole blocking layer and an electron transport layer. On the organic functional layer unit C, for example, a transparent electrode 16 is provided as the negative electrode. Lastly, a sealing member (sealing layer) is provided as a topmost layer.

In conventional organic EL element panels, for example, indium-tin mixed oxide (hereinafter abbreviated as ITO), which has a certain level of light transmittance, has been used for a positive electrode, i.e. the transparent electrode 12. In contrast, a vapor-deposited metal film of aluminum or the like has been used for a negative electrode, i.e. the transparent electrode 16, but such negative electrode materials have poor light transmittance. Therefore, organic EL element panels of such configuration have a light transmittance of 60% or less, and are not suitable for a light emitting image display apparatus.

In the present invention, by using a material having very high light transmittance, specifically a silver thin film electrode having a thickness within the range of 4.0 to 10 nm for one of the transparent electrode 12 and the transparent electrode 16 of FIG. 7, preferably for both of them, the organic EL element panel achieves the light transmittance T_{c} of 65% or more at a wavelength of 550 nm, which opens the applicability to interior lighting members of a passenger cabin.

The layer structure of the organic EL element panel as illustrated in FIG. 7 is only a preferred embodiment, and the present invention is not limited thereto. For example, the organic EL element panel according to the present invention may have any one of the following layer structures (i)-(v).

(i) support substrate/positive electrode/light emitting layer/electron transport layer/negative electrode/sealing adhesive/sealing member.

(ii) support substrate/positive electrode/hole transport layer/light emitting layer/electron transport layer/negative electrode/sealing adhesive/sealing member.

(iii) support substrate/positive electrode/hole transport layer/light emitting layer/hole blocking layer/electron transport layer/negative electrode/sealing adhesive/sealing member.

(iv) support substrate/positive electrode/hole transport layer/light emitting layer/hole blocking layer/electron transport layer/negative electrode buffer layer/negative electrode/sealing adhesive/sealing member.

(v) support substrate/positive electrode/positive electrode buffer layer/hole transport layer/light emitting layer/hole blocking layer/electron transport layer/negative electrode buffer layer/negative electrode/sealing adhesive/sealing member.

### Organic Functional Layer of Organic EL Element Panel

Next, the components of the organic EL element panel according to the present invention will be described.

(1) Injection Layer: Hole Injection Layer, Electron Injection Layer

In the organic EL element panel according to the present invention, an injection layer may be provided as necessary. The injection layer may be the electron injection layer or the hole injection layer, and may be present between the positive electrode and the light emitting layer or hole transport layer and between the negative electrode and the light emitting layer or electron transport layer.

As used herein, an injection layer is a layer that is provided between the electrode and the organic functional layer in order to decrease the drive voltage and to enhance the light emission intensity. Details are described in “Forefront of Organic EL Element and the Industrialization Thereof” (Nov. 30, 1998, NTS Inc.), Part 2, Chapter 2 “Electrode Materials” (pp. 123-166). An injection layer may be a hole injection layer or an electron injection layer.

Hole injection layers are described in detail in, for example, JP H09-45479A, JP H09-260062A, JP H08-288069A and the like. Hole injection materials that can be used for the hole injection layer include polymers containing triazole derivatives, oxadiazole derivatives, imidazole derivatives, pyrazoline derivatives and pyrazolone derivatives, phenylenediamine derivatives, arylamine derivatives, amino-substituted chalcone derivatives, oxazole derivatives, styrylanthracene derivatives, fluorenone derivatives, hydrazone derivatives, stilbene derivatives, silazane derivatives or the like; aniline copolymers; polyarylalkane derivatives; and electrically conductive polymers. Preferred materials are polythiophene derivatives, polyaniline derivatives, polypyrrole derivatives. Polythiophene derivatives are more preferred.

In the organic EL element panel according to the present invention, the electron injection layer may be either present or absent. Electron injection layers that can be used in the present invention are described in detail in, for example, JP H06-325871A, JP H09-17574A, JP H10-74586A and the like. Specifically, such layers include metal buffer layers of strontium, aluminum or the like, alkali metal compound buffer layers of lithium fluoride or the like, alkali earth metal compound buffer layers of magnesium fluoride or the like, oxide buffer layers of aluminum oxide or the like. In the present invention, it is desirable that such buffer layers (injection layers) are a thin film, and are preferably made of potassium fluoride or sodium fluoride. The film thickness is within the range from 0.1 nm to 5 μm, preferably within the range from 0.1 to 100 nm, more preferably within the range from 0.5 to 10 nm, most preferably within the range from 0.5 to 4 nm.

(2) Hole Transport Layer

Hole transport materials that can be used for the hole transport layer according to the present invention may be the same as those used for the hole injection layer. Among them, porphyrin compounds, aromatic tertiary amine compounds and styrylamine compounds, particularly aromatic tertiary amine compounds are preferably used.

In the present invention, the hole transport layer may be formed by applying the material by a wet process (e.g. spin coating, casting, and printing including an ink-jet method) and drying it. Further, the hole transport layer may be formed by other methods. For example, a vacuum deposition method, a Langmuir-Blodgett (LB) method or other method known in the art may be used to form a thin film.

(3) Electron Transport Layer

The electron transport layer according to the present invention is made of a material that has a function of transporting electrons. In a broad sense, the electron injection layer and the hole blocking layer are also included in electron transport layers. The electron transport layer may be a single layer, or a plurality of electron transport layers may be provided. For example, it may be provided as a combination of the hole blocking layer and the electron transport layer.

When a single layer or a plural layers of the electron transport layer is/are provided, the electron transport layer adjacent to the light emitting layer on the side of the negative electrode may be made of any electron transport material (or also hole blocking material) that has a function of transporting electrons injected from the negative electrode to the light emitting layer. Such materials include those selected from compounds known in the art, for example, metal complexes of fluorene derivatives, carbazole derivatives, azacarbazole derivatives, oxadiazole derivatives, triazole derivatives, silole derivatives, pyridine derivatives, pyrimidine derivatives, 8-quinolinol derivatives and the like.

(4) Light Emitting Layer

The light emitting layer of the organic EL element panel according to the present invention emits light by recombination of electrons and holes that are injected from the electrodes or the electron transport layer and the hole transport layer. The light emitting part may be located in the light emitting layer or at the interface with the adjacent layer.

The light emitting layer mainly contains a dopant compound and a host compound. The materials of the light emitting layer according to the present invention are characterized by being low molecular weight organic compounds. As used herein, a low molecular weight compound is defined as a compound having a molecular weight of 1500 or less.

Hereinafter, the dopant compound and the host compound will be described individually.

(4.1) Host Compound

It is preferred that the host compound that is contained in the light emitting layer of the organic EL element panel according to the present invention has a phosphorescence quantum yield of less than 0.1 at room temperature (25° C.). More preferably, the phosphorescence quantum yield is less than 0.01. Further, the host compound may be included in non-light emitting organic materials.

By using two or more known host compounds and light emitting materials (described below), different luminescent colors can be obtained. Then, by mixing them, any luminescent color such as white luminescent color can be obtained.

Specific examples of known host compounds include those disclosed in the following documents. For example, JP 2001-257076A, JP 2002-308855A, JP 2001-313179A, JP 2002-319491A, JP 2001-357977A, JP 2002-334786A, JP 2002-8860A, JP 2002-334787A, JP 2002-15871A, JP 2002-334788A, JP 2002-43056A, JP 2002-334789A, JP 2002-75645A, JP 2002-338579A, JP 2002-105445A, JP 2002-343568A, JP 2002-141173A, JP 2002-352957A, JP 2002-203683A, JP 2002-363227A, JP 2002-231453A, JP 2003-3165A, JP 2002-234888A, JP 2003-27048A, JP 2002-255934A, JP 2002-260861A, JP 2002-280183A, JP 2002-299060A, JP 2002-302516A, JP 2002-305083A, JP 2002-305084A, JP 2002-308837A and the like.

(4.2) Light Emitting Material

As the light emitting material (light emitting dopant) according to the present invention, fluorescent compounds and phosphorescence emitting materials (also referred to as phosphorescent compounds, phosphorescent light emitting compound and phosphorescent dopant compounds) can be used. Phosphorescent dopant compounds are preferred.

The phosphorescence emitting material may be suitably selected from those known in the art used for the light emitting layer of organic EL element panels. Preferred materials are complexes containing a metal of Group VIII to X in the periodic table, and more preferred materials are iridium compounds, osmium compounds, platinum compounds (platinum complexes) and rare earth complexes. Among them, the most preferred materials are iridium compounds.

(5) Transparent Electrode

In the organic EL element panel according to the present invention, it is important to use the planar electrodes (transparent electrode) having high light transmittance in order to achieve a light transmittance T_{c} of 65% or more. For the planar electrodes having high light transmittance, ordinary known transparent electrodes can be used. For example, such electrodes include metal oxide electrodes such as indium-tin mixed oxide (ITO) and indium-zinc oxide (IZO), electrically conductive polymer electrodes such as polythiophene and polyaniline, and metal thin film electrodes such as silver film and copper film. To achieve the desired light transmittance, the panel is designed such that each transparent electrode has a light transmittance T_{c} of preferably 80% or more.

On the other hand, high electrical conductivity is required for the transparent electrodes. Most conventional transparent electrodes cannot keep sufficient electrical conductivity when they are formed thin in order to increase the light transmittance. In the present invention, it is preferred to use a silver film electrode as described below as the transparent electrodes that have both high light transmittance and high electrical conductivity.

The transparent electrodes according to the present invention have a specific surface resistance preferably within the range from 0.3 to 200 Ω/□, more preferably within the range from 0.5 to 100 Ω/□, particularly within the range from 1 to 50 Ω/□. The surface specific resistance can be measured, for example, according to JIS K6911, ASTM D257 or the like, and can be readily measured by using a commercially available surface specific resistance meter.

Silver Film Electrode

The silver film electrode is a layer of silver or a silver-based alloy. Film forming methods of the silver film electrode layer include methods using a wet process such as application method, ink-jet method, coating method and dipping method and methods using a dry process such as vapor deposition (resistance heating, an EB method and the like), sputtering and CVD. Among them, vapor deposition is preferably used. If necessary, the formed film may be treated with high temperature annealing.

Silver (Ag)-based alloys that can be used for the silver film electrode layer include silver-magnesium (AgMg), silver-copper (AgCu), silver-palladium (AgPd), silver-palladium-copper (AgPdCu), silver-indium (Ag—In) and the like. The electrode may be a laminate of a plurality of layers each made of silver or a silver-based alloy according to need.

When the film thickness is within the range from 4 to 10 nm, the silver film electrode layer exhibits high light transmittance without losing the electrical conductivity, and can therefore be used for the organic EL element panel. In the present invention, it is particularly preferred that the thickness is within the range from 4 to 9 nm. The thickness equal to or less than 10 nm can reduce absorption or reflection of light so as to achieve the desired transmittance required for the transparent electrodes. Further, the thickness equal to or greater than 4 nm ensures sufficient electrical conductivity, and also enables stable and continuous film formation. In the present invention, it is preferred that at least one of the planar electrodes, i.e. the positive electrode, the negative electrode, and if necessary, an intermediate electrode, is a silver film electrode. More preferably, all electrodes are silver film electrodes.

It is preferred that the silver film electrode layer is formed by applying silver or a silver alloy on a base layer containing a nitrogen-containing compound by any of the above-described methods. Interaction between the silver atoms of the electrode layer and the nitrogen-containing compound of the base layer reduces the diffusion distance of the silver atoms on the surface of the base layer to prevent aggregation of the silver. This allows the silver film to grow in the monolayer growth mode (Frank-van der Merwe: FM mode), while silver films generally tend to grow in the nucleation growth mode (Volumer-Weber: VW mode) to form isolated islands. Therefore, it becomes possible to obtain the electrode layer having thin and uniform film thickness. As a result, it becomes possible to reduce the film thickness of the transparent electrodes to achieve high light transmittance while securing the electrical conductivity.

(6) Support Substrate

Transparent support substrates such as glass or plastic substrates can be used for the organic EL element panels according to the present invention. Transparent support substrates that can be used include glass, quartz, transparent resin films, and the like.

Such resin films include, for example, polyesters such as polyethylene terephthalate (PET) and polyethylene naphthalate (PEN), polyethylene, polypropylene, cellophane, cellulose esters such as cellulose diacetate, cellulose triacetate (TAC), cellulose acetate butylate, cellulose acetate propionate (CAP), cellulose acetate phthalate and cellulose nitrate and the derivatives thereof, polyvinylidene chloride, polyvinyl alcohol, polyethylene vinylalcohol, syndiotactic polystyrene, polycarbonate, norbornene resins, polymethylpentene, polyether ketone, polyimide, polyether sulfone (PES), polyphenylene sulfide, polysulfones, polyether imide, polyether ketone imide, polyamide, fluorinated resin, nylon, polymethyl methacrylate, acrylic resins or polyarylates, cyclic olefin polymers such as Arton (product name, JSR Corp.) and Apel (product name, Mitsui Chemicals, Inc.), and the like.

### INDUSTRIAL APPLICABILITY

The interior lighting method of the present invention is applicable as an interior lighting method that can eliminate a sense of confinement and oppression in a passenger cabin of a vehicle.

### DESCRIPTION OF REFERENCE NUMERALS

1 passenger cabin

2 window panel

3 window

4 seat

5 image display member

6, 6A, 6B, 6C, 6D light emitting member (organic EL element panel)

11 support substrate

12 transparent electrode (positive electrode)

13, 15 organic functional layer

14 organic light emitting layer

16 transparent electrode (negative electrode)

17 sealing member

21 sensor unit or camera unit

22 cockpit

23 image processing unit

24 recording unit

25 image controlling unit

26 onboard lighting controlling unit

In the claims:

1. A passenger cabin lighting method by lighting equipment that is provided on a window panel in a passenger cabin of a vehicle, comprising:
simulating image information on an outside of a window of the vehicle; and
allowing the lighting equipment to emit light based on the image information.

2. The passenger cabin lighting method according to claim 1, wherein the vehicle is an aircraft.

3. The passenger cabin lighting method according to claim 1,
wherein the image information on the outside of the window is acquired by a sensor unit or a camera unit that is installed in the vehicle, and the acquired image information is simulated by an image processing unit, and
wherein the lighting equipment disposed on the window panel emits light based on hue, brightness and saturation of the simulated image information.

4. The passenger cabin lighting method according to claim 1,
wherein the image information on the outside of the window is analyzed based on positional information of the vehicle, time information and weather information, and is simulated based on the analyzed image information by an image processing unit, and
wherein the lighting equipment disposed on the window panel emits light based on hue, brightness and saturation of the simulated image information.

5. The passenger cabin lighting method according to of claim 1,
wherein the lighting equipment provided on the window panel comprises a plurality of lighting member that are arranged in separate blocks, and
wherein the plurality of lighting members are organic electroluminescent element panels.

6. The passenger cabin lighting method according to claim 1, wherein the step of simulating the image information on the outside of the window of the vehicle comprises the following sub-steps 1) to 3):
1) acquiring the image information on the outside of the vehicle by a sensor unit or a camera unit;
2) dividing the acquired image information; and
3) determining representative colors of respective divided image parts.

7. The passenger cabin lighting method according to claim 5, wherein the organic electroluminescent element panels have a light transmittance T of 65% or more at a wavelength of 550 nm in a non-light emitting state.

8. The passenger cabin light emitting method according to claim 5, wherein the organic electroluminescent element panels are controllable in luminescent color.

9. An organic electroluminescent element panel structured for use in a passenger cabin lighting method.
wherein lighting equipment is provided on a window panel in a passenger cabin comprising:
simulating image information regarding an outside of a window; and
allowing the lighting equipment to emit light based on the image information.
